(19) United States
(12) Patent Application Publication
(10) Pub. No.: US 2018/0291300 A1
(43) Pub. Date: Oct. 11, 2018

(54) GREASE COMPOSITION AND ROLLING BEARING

(71) Applicant: MINEBEA MITSUMI Inc., Nagano (JP)

(72) Inventor: Motojiro TSUNA, Nagano (JP)

(21) Appl. No.: 15/948,137

(22) Filed: Apr. 9, 2018

(30) Foreign Application Priority Data
Apr. 10, 2017 (JP) 2017-077780
Mar. 14, 2018 (JP) 2018-46904

(51) Int. Cl. C10M 115/08; C10M 105/06; C10M 105/04; C10M 101/02; C10M 105/36; C10M 169/02; F16C 33/66

(52) U.S. Cl. CPC C10M 115/08; C10M 105/06; C10M 105/04; C10M 101/02; C10M 105/36; C10M 169/02; C10N 2240/02; C10M 2203/024; C10M 2203/1006; C10M 2203/065; C10M 2207/2855; C10M 2215/1026; C10N 2250/10; F16C 33/6633

(57) ABSTRACT

A grease composition includes alkylnaphthalene as base oil and a urea compound as thickening agent. The thickening agent is an alicyclic aliphatic diurea compound contained at a ratio of 4 mass % to 10 mass % based on the total mass of the grease composition. A pivot assembly bearing device is provided with rolling bearings filled with the above grease composition. A hard disk drive device is provided with a swing arm which is swingably supported by the pivot assembly bearing device.

### BACKGROUND OF THE INVENTION

### 1. Field of the Invention

The present invention relates to a grease composition, a rolling bearing filled with the grease composition, and a pivot assembly bearing device provided with the rolling bearing. The present invention also relates to a hard disk drive device provided with the pivot assembly bearing device.

### 2. Description of the Related Art

In a hard disk drive device that is a computer storage device, data is recorded on a magnetic disk, and recorded data is read from the magnetic disk by moving a magnetic head over the magnetic disk. Generally, the magnetic head is mounted at the tip of a swing arm swingably supported by rolling bearings, and a bearing device that swingably supports the swing arm is called a pivot assembly bearing device. Various lubricants have been proposed to smoothly driving the pivot assembly bearing device. For example, a grease composition containing a mixed base oil of a mineral oil and polyalphaolefin, and a urea compound has been proposed (see Patent Document 1 of Japanese Patent Application Laid-Open No. 2003-239954).

Further, in order to provide a grease composition with especially excellent quietness, long acoustic life and low torque, and to provide a rolling bearing using the grease composition, Japanese Patent Application Laid-Open No. 2005-132900 (Patent Document 2) proposes: a grease composition including a thickening agent composed of a metal soap or a polyurea compound and a base oil containing specific alkylnaphthalene; and a rolling bearing where a plurality of rolling elements are held rollably between an inner ring and an outer ring and where the above grease composition is enclosed.

Still further, in order to provide a rolling bearing for a machine tool which maintains a smooth rotation even under a high-speed and heavy-load condition exceeding dmN of 1,000,000 and which is maintenance-free, and to provide a grease composition suitable for the rolling bearing, Japanese Patent Application Laid-Open No. 2013-18861 (Patent Document 3) proposes: a grease composition in which at least one of alkyl diphenyl ether and alkylnaphthalene is used as a base oil, a urea compound is used as a thickening agent and consistency is NLGI consistency number 3 to 4; and the rolling bearing for the machine tool in which to enclose the aforementioned grease composition and to be applicable even over dmN of 1,000,000.

In recent years, along with the tendency for miniaturization in hard disk drive devices, the increase of the capacity and density of recorded information, and the increase of processing speed, the gap between the magnetic head and the magnetic disk has been reduced, so that the magnetic head has been required to travel a shorter distance in a shorter time more frequently.

Due to this requirement, the pivot assembly bearing device is now subjected to repetition of quick starts and quick stops more than ever thus facing more substantive burden. Therefore, a lubricant is required which can make the pivot assembly bearing device being stably driven for a long period of time at low torque and reduced torque fluctuation. In particular, a grease composition containing a urea-based thickening agent tends to harden with time. Such hardening of the grease composition causes large fluctuation of torque, so that it is important to suppress the age hardening of the grease composition. In addition, since hard disk drives and pivot assembly bearing devices have been downsized, the amount of grease composition enclosed in the pivot assembly bearing device has been decreased. Therefore, for obtaining sufficient lubricity even with the small amount of grease composition, it has been necessary to increase the ratio of the base oil relative to the thickening agent because the base oil is the main element contributing to the lubricity.

The object of the present invention is to provide a grease composition that can suppress local rise in torque due to grease age hardening, that can prevent lubrication failure and oil leakage, and that can expect initial and long-term torque stability due to excellent grease shape retainability (capability to retain original shape of grease as enclosed). Further, the object of the present invention is to provide a rolling bearing in which the above-mentioned grease composition is enclosed.

### SUMMARY OF THE INVENTION

The inventor of the present invention has found that a grease composition not proposed so far, which combines alkylnaphthalene as a base oil, and an alicyclic aliphatic diurea compound as a thickening agent, allows to reduce the amount of the urea-based thickening agent to 10% or less, thereby suppressing the age hardening of the grease. Further, the inventor has also found that the above grease composition, in which the specific amount of the urea-based thickening agent is mixed, not only inhibit the grease age hardening but also provides a proper oil separation amount capable of preventing insufficient lubricant supply as well as oil leakage. Still further, in this grease composition, fluidity (grease shape retainability) evaluated based on storage elastic modulus, torque and the like is found to be excellent resulting in a long life.

Specifically, the present invention relates to a grease composition containing (a) alkylnaphthalene as a base oil and (b) a urea compound as a thickening agent, in which the thickening agent (b) is an alicyclic aliphatic diurea compound contained at a ratio of 4 mass % to 10 mass % based on the total mass of the grease composition.

In a preferred embodiment, the thickening agent (b) may be contained at a ratio of 6 mass % to 10 mass % based on the total mass of the grease composition.

Further, in a preferred embodiment, when the grease composition according to an embodiment of the present invention is left for 1000 hours under the environment of 100° C., a rate that the grease composition hardens with time (hereinafter referred to as “age hardening rate”) calculated according to the following formula preferably does not exceed 20%.

Age hardening rate (%)=[(X−Y)/X]×100,

where “X” is unworked penetration of the grease composition before being left for 1000 hours under the environment of 100° C., and “Y” is unworked penetration of the grease composition after being left for 1000 hours under the environment of 100° C.

Still further, the grease composition according to an embodiment of the present invention preferably has an oil separation amount between 200 mm²/mg and 300 mm²/mg. The oil separation amount corresponds to the area of oil bleeding portion appearing on a medicine paper per mass of the grease composition. The area of oil bleeding portion is measured after leaving the grease composition of 9 mg in a form of a column of 3 mm diameter on the medicine paper for 24 hours under the environment of 80° C.

Yet still further, the present invention also includes a rolling bearing in which the above-mentioned grease composition is enclosed. In addition, the present invention includes a pivot assembly bearing device provided with the above rolling bearing, the pivot assembly bearing device being able to swingably support the swing arm of a hard disk drive device, and a hard disk drive device provided with the above pivot assembly bearing device.

In the grease composition according to an embodiment of the present invention, use of alkylnaphthalene as a base oil enables to reduce the content of a urea-based thickening agent to 10% or less, so that the age hardening rate, which is a problem when using the urea-based thickening agent, can be reduced. Accordingly, it is expected that local rise in torque (bump) due to grease age hardening can be reduced.

Further, in the grease composition according to an embodiment of the present invention, it is possible to achieve an appropriate range of the oil separation amount, so that it is expected to prevent problems such as torque fluctuation due to the insufficient supply of lubricant, or contamination due to oil leakage.

Still further, since the grease composition according to an embodiment of the present invention is excellent in fluidity (grease shape retainability) evaluated based on storage elastic modulus, torque, etc. and life, initial and long-term stabilities of torque are expected.

Consequently, the grease composition according to an embodiment of the present invention can be suitably used, especially for a rolling bearing provided in a pivot assembly bearing device that swingably supports the swing arm of a hard disk drive device.

According to the present invention, the grease composition with the above composition is applicable to the rolling bearing, and especially to the rolling bearing for the pivot assembly bearing device that swingably supports the swing arm of the hard disk drive device, by which the above rolling bearing can be stably driven for a long period at low torque with small torque fluctuation. This low torque with small torque fluctuation contributes to suppression of disk reading errors in the hard disk drive. In addition, this low torque with small torque fluctuation can extend the life of a rolling bearing using the grease composition according to an embodiment of the present invention, the life of a pivot assembly bearing device provided with such rolling bearing, and eventually the life of a hard disk drive device provided with such pivot assembly bearing device.

### BRIEF DESCRIPTION OF THE DRAWINGS

FIG. 1 is a schematic view (cross-sectional view) exemplifying the structure of a rolling bearing according to an embodiment of the present invention;

FIG. 2 is a schematic view (perspective view) exemplifying the structure of a hard disk drive device according to an embodiment of the present invention;

FIG. 3 is a schematic view (cross-sectional view) exemplifying the structure of a pivot assembly bearing device according to an embodiment of the present invention; and

FIG. 4 is a view showing a rotational rheometer used for torque measurement in the embodiments according to the present invention and the comparative examples.

### DETAILED DESCRIPTION OF THE PREFERRED EMBODIMENTS

The grease composition of the present invention contains a base oil and a thickening agent.

<Base Oil>

The grease composition according to an embodiment of the present invention includes alkylnaphthalene as the base oil. The kinematic viscosity of alkylnaphthalene at 40° C. is preferably in the range of 20 to 80 cSt. By adopting such alkylnaphthalene, it becomes possible to reduce the amount of the thickening agent, later described in details, to less than 10% whereby a grease composition with excellent shape retainability, oil separation characteristic and long-life characteristic is obtained.

The base oil is preferably contained in a proportion of 80% by mass or more based on the total mass of the grease composition. For example, the base oil may be contained in a proportion of 80% by mass to 93% by mass based on the total mass of the grease composition.

<Thickening Agent>

Since a urea compound is excellent in both heat resistance and water resistance and particularly excellent in stability at high temperature, it is suitably used as a thickening agent in areas under high temperature environment. Especially, from the viewpoint of heat resistance and acoustic characteristic (quietness), diurea compounds have been widely used.

The grease composition according to an embodiment of the present invention includes a urea compound, specifically an alicyclic aliphatic diurea compound, as the thickening agent.

As the alicyclic aliphatic diurea compound, for example, the diurea compound represented by the following general formula (1) can be mentioned.

R₁—NHCONH—R₂—NHCONH—R₃ (1)

(In the formula, while one of R₁ and R₃ represents a monovalent alicyclic hydrocarbon group, the other represents a monovalent aliphatic hydrocarbon group, and R₂ represents a divalent aromatic hydrocarbon group.)

The monovalent aliphatic hydrocarbon group includes, for example, a linear or branch-chained, saturated or unsaturated aliphatic hydrocarbon group having 6 to 26 carbon atoms.

Examples of the monovalent alicyclic hydrocarbon group include an alicyclic hydrocarbon group having 5 to 12 carbon atoms.

Examples of the divalent aromatic hydrocarbon group include a divalent aromatic hydrocarbon group having 6 to 20 carbon atoms.

The alicyclic aliphatic diurea compound used in the present invention is synthesizable using an amine compound and an isocyanate compound. For example, the alicyclic aliphatic diurea compound is obtainable by using alicyclic amine and aliphatic amine as amine raw materials and by synthesizing them with aromatic diisocyanate.

Examples of the amine compound above may include aliphatic amines represented by hexyl amine, octyl amine, dodecyl amine, hexadecyl amine, octadecyl amine (stearyl amine), behenyl amine, oleyl amine and the like, and alicyclic amines represented by cyclohexylamine and the like.

Further, as the isocyanate compound, aromatic diisocyanates such as phenylene diisocyanate, tolylene diisocyanate (TDI), diphenyl diisocyanate, diphenyl methane diisocyanate (MDI), dimethyl biphenyl diisocyanate (TODI) and the like are used.

The above thickening agent is contained at a ratio of 4 mass % to 10 mass % based on the total mass of the grease composition according to an embodiment of the present invention. When the thickening agent is used in an amount exceeding 10% by mass, the oil separation amount of the grease composition becomes too small which may result in a poor lubrication. On the other hand, if the thickening agent is used in an amount less than 4 mass %, the oil separation amount becomes too large may cause not only the contamination of the device but also the deterioration of fluidity.

In particular, from the viewpoint to obtain a grease composition with an appropriate oil separation amount as well as an excellent fluidity and long life, it is preferable to include the thickening agent at a ratio of, for example, 6% by mass to 10% by mass.

<Other Additives>

In addition to the above main components, if necessary, the grease composition may contain additives usually used in a grease composition as long as the effects of the present invention are not impaired.

Examples of such additives may include antioxidants, rust inhibitors, extreme pressure agents, metal deactivators, friction inhibitors (anti-wear agents), oiliness improvers, viscosity index improvers, thickening agents and the like.

When the other additives are added, although the total amount to be added is not particularly limited, it is normally 0.1 to 10% by mass, for example 3 to 10% by mass, with respect to the total amount of the grease composition.

Examples of the above antioxidants may include: hindered phenol based antioxidants such as octadecyl-3-(3,5-di-t-butyl-4-hydroxyphenyl)propionate, pentaerythritol tetrakis[3-(3,5-di-t-butyl-4-hydroxyphenyl)propionate], 2,4-bis-(n-octylthio)-6-(4-hydroxy-3,5-di-t-butylanilino)-1,3,5-triazine, 1,3,5-trimethyl-2,4,6-tris (3,5-di-t-butyl-4-hydroxybenzyl)benzene, triethylene glycol-bis [3-(3-t-butyl-5-methyl-4-hydroxyphenyl)propionate], 1,6-hexanediol-bis[3-(3,5-di-t-butyl-4-hydroxyphenyl)propionate], 2,2-thio-diethylenebis[3-(3,5-di-t-butyl-4-hydroxyphenyl) propionate], N, N′-hexamethylenebis(3,5-di-t-butyl-4-hydroxy-hydrocinnamide), and the like; phenol based antioxidants such as 2,6-di-t-butyl-4-methylphenol, 4,4-methylenebis (2,6-di-t-butylphenol), and the like; and amine based antioxidants such as diphenylamine, triphenylamine, hindered amine, phenyl-α-naphthylamine, alkylated phenyl-α-naphthylamine, phenothiazine, alkylated phenothiazine and the like.

Examples of the extreme pressure agents may include: phosphorus based compounds such as orthophosphoric acid esters, phosphite, phosphate ester amine salts, and the like; sulfur based compounds such as sulfides, disulfides and the like; chlorine based compounds such as chlorinated paraffin, chlorinated diphenyl and the like; and metal salts of sulfur based compounds such as zinc dialkyldithiophosphate, molybdenum dialkyldithiocarbamate, and the like.

Examples of the metal deactivators may include benzotriazole, sodium nitrite and the like.

Examples of the anti-wear agents may include tricresyl phosphate and a high polymerized ester. Examples of the high polymerized esters may include esters of aliphatic monovalent carboxylic acids and divalent carboxylic acids with polyhydric alcohols. As a specific example of the high polymerized esters, PRIOLUBE (registered trademark) series manufactured by Croda Japan Co., Ltd., may be mentioned. However, the anti-wear agent is not limited to the above examples.

<Age Hardening Rate>

The grease composition of the present invention is preferably a grease composition with low age hardening rate. The reason is explained below.

The rolling bearing device that swingably supports the swing arm of the hard disk drive device is known as pivot assembly bearing device. The grease composition according to an embodiment of the present invention is particularly suitable to be applied in a pivot assembly bearing device. Unlike a rolling bearing device for general purpose which normally operates rotating only in one direction, the pivot assembly bearing device performs oscillatory motion with repeated rotations in both directions at a minute angle.

In the pivot assembly bearing device, grease with channeling characteristics (property indicating how easy the grease in a bearing is pushed aside by a rolling element) is generally used. When the pivot assembly bearing device swings, grease sealed in the bearing device is pushed aside and accumulates at both lateral sides of oscillation path, that is, both sides of balls in the rolling bearing. Since the accumulated grease is not subjected to shearing (that is, remain still), it tends to harden with time. Thus, when the hardening of grease occurs, torque fluctuates greatly because the torque rises when the balls try to roll over hardened material. This tends to cause disk reading errors in hard disk drives. The phenomenon in which the torque rises when balls passes over hardened materials is called a “bump.”

Grease mixed with urea-based thickening agents has tendency to harden with time, and thus understanding the age hardening characteristic of the grease is important in predicting the occurrence of bumps in the actual bearing devices. As the grease with a low age hardening rate can reduce the hardening over an extended period of time, the use of grease with low age hardening rate leads to the reduction of the bump occurrence in the actual bearing devices. This thus eventually suppresses disk reading errors and extends the life span of the hard disk drive device.

Based on the above background, the present inventor has conducted evaluation of the age hardening rate of grease applying the inventor's own evaluation method as follows.

The age hardening rate (%) of grease was calculated as described below after leaving the grease in a container for a certain period of time. Specifically, a certain amount of the grease was placed flat in a glass petri dish, and left for 1000 hours under the environment of 100° C. Then, unworked penetration of the grease was periodically measured, and values calculated by Formula 1 mentioned later were defined as age hardening rate (%).

In this regard, each age hardening rate of conventional grease was measured based on the above definition. As a result, for the conventional grease where age hardening rates were 50 to 60% after left for 1000 hours under the environment of 100° C., bump occurrence was confirmed in the actual device. Further, even for the conventional grease with the age hardening rates of 20 to 30%, although the frequency of bump occurrence in the actual device reduced, some bumps was still verified. This result shows that, the lower age hardening rate of the grease is, the less the bump in the actual device occurs.

Based on the above result, the grease composition according to an embodiment of the present invention was considered good when the age hardening rate calculated by the Formula 1 did not exceed 20% after the grease composition being placed flat in a glass petri dish and left for 1000 hours under the environment of 100° C.

Age hardening rate (%)[(X−Y)/X]×100 (Formula 1)

X: Unworked penetration of a grease composition before being left for 1000 hours under the environment of 100° C.
Y: Unworked penetration of the grease composition after being left for 1000 hours under the environment of 100° C.

<Oil Separation Amount>

For the grease composition according to an embodiment of the present invention, the oil separation amount is preferable to be within a proper range. This reason is explained below.

Conventionally, there is test method such as JIS K2220 to measure the oil separation amount of a grease for evaluating the amount of oil (base oil) bleeding from the grease. Since the life of grease varies depending on the amount of oil separation, determination of the oil separation amount is important not only for understanding the life characteristic of grease but also for achieving an appropriate lubrication performance.

For example, in a pivot assembly bearing device that applies grease to a grease reservoir portion located between the ball pockets of a crown type retainer, lubricant (base oil) to be supplied to the balls over time may become insufficient if the oil separation amount is too small, leading to the occurrence of torque instability and seizure of bearing. On the other hand, if the oil separation amount is too large, this tends to cause contamination due to oil leakage.

Grease containing a urea-based thickening agent generally has small amount of oil separation. Thus, when measuring the oil separation amount of urea grease repeatedly over time following an oil separation measurement method according to a standard such as JIS K2220, which defines a measuring method of the oil separation degree, clear differences hardly can be seen in the measurement results in some cases.

Therefore, in the present invention, the inventor's own method was adopted in order to clearly reveal the differences in the oil separation amount. Specifically, the grease composition of 9 mg was set on a piece of medicine paper in a form of 3 mm diameter column and left for 24 hours under the environment of 80° C. In this condition, the area of portions where oil bleeding (base oil bleeding) occurred on the medicine paper was measured. The area of the oil bleeding portion per mass of the grease is thus defined as the oil separation amount (mm²/mg).

Based on the above definition, this particular method was adopted to conventional greases which no lubrication failure has been yet verified. Applying the particular method, it was confirmed that the oil separation amounts for the most of conventional greases were within about 230 to 280 mm²/mg. For the conventional grease with the oil separation amount of 200 mm²/mg or less, seizing due to lubrication failure was verified. Considering that the excessive oil separation causes oil leakage, the upper limit value of the oil separation amount was defined as 300 mm²/mg.

In accordance with the above results, 9 mg of the grease composition according to an embodiment of present invention was set on a piece of medicine paper in a form of 3 mm diameter column and left for 24 hours under the environment of 80° C. The area of oil bleeding portions appeared on the medicine paper was then measured. As a result, the oil separation amount corresponding to the area of oil bleeding portions per mass of the grease composition was evaluated to be proper for values in the range of 200 mm²/mg to 300 mm²/mg, and more preferably in the range of 230 mm²/mg to 280 mm²/mg.

[Rolling Bearing]

Some preferable embodiments of the rolling bearing according to the present invention will be described in detail below with reference to the accompanying drawings. It should be noted that the present invention is not limited by any of the following embodiments.

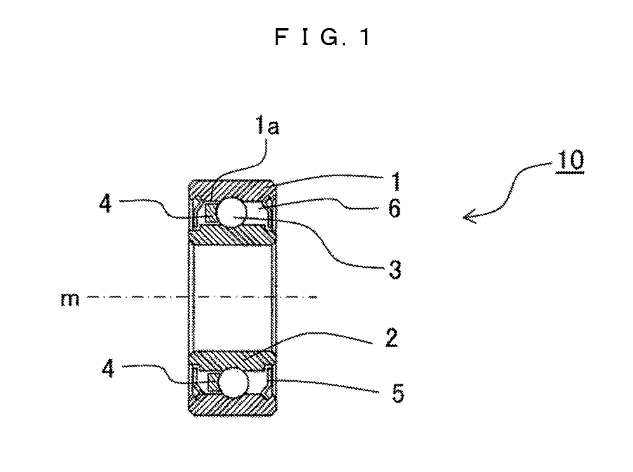

FIG. 1 is the sectional view of a rolling bearing (ball bearing) 10 according to one of the preferred embodiments of the present invention. The rolling bearing 10 of the embodiment shown in FIG. 1 includes a cylindrical outer ring 1 having a rotation axis m as the center axis, a cylindrical inner ring 2 provided coaxially with the outer ring 1 on the inner peripheral side of the outer ring 1, balls 3 which correspond to a plurality of rolling elements arranged in a raceway 6 formed between the outer ring 1 and the inner ring 2, a retainer 4 arranged in the raceway 6 to hold the ball 3, seals 5 extending from both ends of the raceway surface 1a of the outer ring 1 facing the inner ring 2 toward the inner ring 2 so as to seal the raceway 6 from the outside, and a grease composition (not shown) according to an embodiment of the present invention enclosed in the area of raceway 6.

Note that the shape (crown type, ribbon type, etc.) and material (steel sheet, resin, etc.) of the retainer 4 are not limited to specific shapes or materials. In addition, the seal 5 may be formed of, for example, a steel plate.

In the rolling bearing 10, frictional resistance is reduced by rolling contact between the outer and inner rings 1, 2 and the plurality of balls 3, and the inner ring 2 rotates in relation to the outer ring 1 about the rotation axis m by rolling of the balls 3. The balls 3 are held by the retainer 4 at predetermined intervals in the circumferential direction of the inner ring 2 and the outer ring 1, enabling to prevent the balls 3 from being fallen off from the rings or from contacting adjacent balls.

Further, frictional resistance between the balls 3 in the raceway 6 and the inner and outer rings 2, 1 can be reduced due to the presence of the grease composition, whereby friction torque is reduced, the generation of frictional heat is also reduced, and the smooth rotation of the inner ring 2 relative to the outer ring 1 is promoted.

In the present embodiment, the amount of the grease composition applied is preferably, for example, about 5% to 30% with respect to the volume of the interior space of the rolling bearing 10, and is more preferably 5% to 10% in a pivot assembly bearing device described later where low torque is especially indispensable. By making the amount of the grease composition to be within this range, the grease composition is able to adequately lubricate the rolling bearing 10, that is, the balls 3 in the raceway 6 and the inner and outer rings 2, 1, thereby enabling to reduce frictional resistance and friction torque. Here, the volume of space inside the rolling bearing 10 corresponds to the volume sandwiched between the outer ring 1 and the inner ring 2, and delimited by the seal 5 but excluding the volume of the balls 3 and the retainer 4.

The rolling bearing 10 of the present embodiment may be used as a rolling bearing provided in pivot assembly bearing devices. With the grease composition according to an embodiment of the present invention, the rolling bearing 10 according to the present embodiment can reduce torque fluctuation thereby accurately positioning the magnetic head. Further, since the torque value is low in the rolling bearing according to the present an embodiment, the response speed of the magnetic head becomes faster.

Moreover, although the rolling bearing 10 according to the present embodiment is suitable for use in pivot assembly bearing devices, the application of the rolling bearing 10 according to the present embodiment is not limited thereto. For example, the rolling bearing 10 can be applied to any motors using small-diameter bearings where low torque is required such as fan motors and stepping motors.

[Pivot Assembly Bearing Device and Hard Disk Drive Device]

Hereinafter, a pivot assembly bearing device provided with the rolling bearing of the above embodiment and a hard disk drive device provided with such pivot assembly bearing device will be explained with reference to the accompanying drawings. It should be noted that the present invention is not limited by any of the following embodiments.

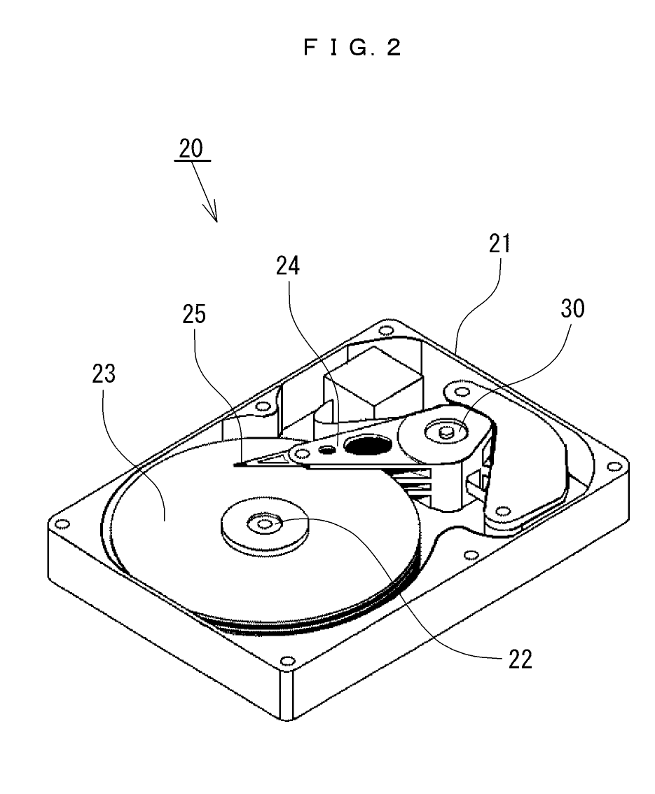

FIG. 2 is the perspective view showing the overall configuration of a hard disk drive device 20 according to one of the preferred embodiments of the present invention. As shown in FIG. 2, the hard disk drive device 20 according to this embodiment includes mainly a substantially rectangular box-shaped baseplate 21, a spindle motor 22 mounted on the baseplate 21, a magnetic disk 23 rotated by the spindle motor 22, a swing arm 24 having a magnetic head 25 for writing information at specified positions on the magnetic disk 23 and reading information from any of the positions, and a pivot assembly bearing device 30 swingably supporting the swing arm 24.

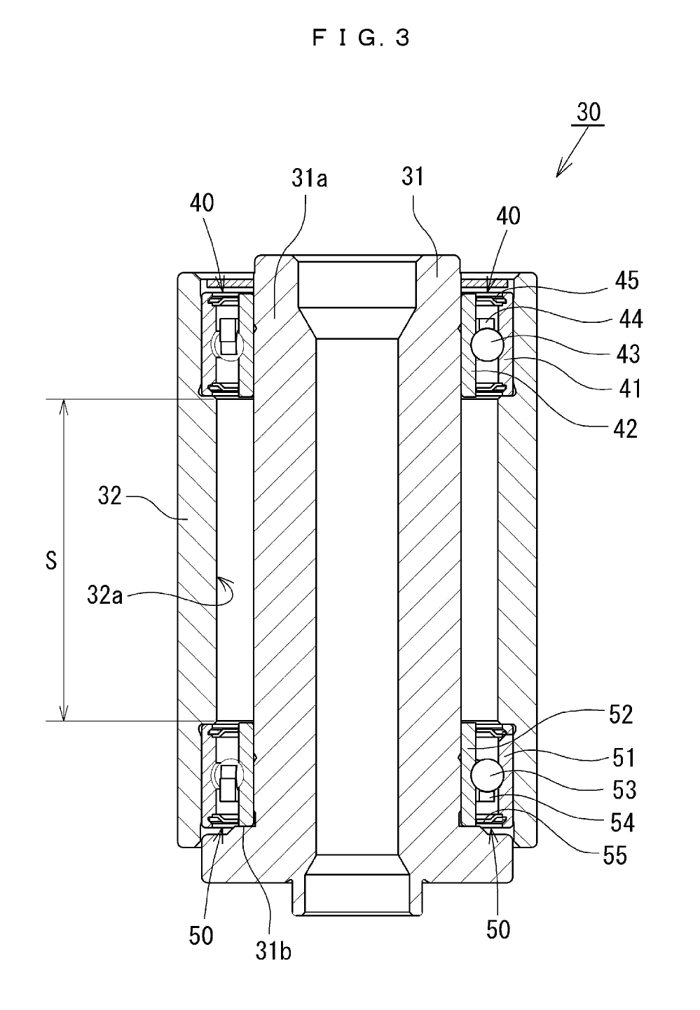

FIG. 3 is the cross-sectional view of the pivot assembly bearing device 30 according to one of the preferred embodiments of the present invention. The pivot assembly bearing device 30 according to the present embodiment includes mainly a shaft 31, two rolling bearings, i.e. a first bearing 40 and a second bearing 50, that are fitted to the shaft 31 separated apart from each other by space S of predetermined length; and a sleeve 32 (outer peripheral member) for attaching the two rolling bearings 40, 50. The sleeve 32 has a spacer portion 32a provided for positioning the two rolling bearings 40, 50 separated by the space S in the axial direction.

The shaft 31 is held rotatably by the first bearing 40 and the second bearing 50. The spacer portion 32a is not limited to the configuration formed in one piece with the sleeve 32 as illustrated in the embodiment of FIG. 3. The sleeve and the spacer may be provided as separate parts.

The rolling bearing 10 according to the above-described embodiment of the present invention is used for the first bearing 40 and the second bearing 50. The first bearing 40 includes mainly a first inner ring 42, a first outer ring 41, balls 43 corresponding to a plurality of rolling elements arranged in a raceway formed between the first inner ring 42 and the first outer ring 41, a retainer 44 arranged in the raceway to hold the balls 43, seals 45 for isolating the raceway from the outside, and the grease composition (not shown) according to an embodiment of the present invention enclosed in the raceway.

Similarly, the second bearing 50 includes mainly a second inner ring 52, a second outer ring 51, balls 53 corresponding to a plurality of rolling elements arranged in a raceway formed between the second inner ring 52 and the second outer ring 51, a retainer 54 arranged in the raceway to hold the balls 53, seals 55 for isolating the raceway from the outside, and the grease composition (not shown) according to an embodiment of the present invention enclosed in the raceway.

The shaft 31 has a tubular shaft main body 31a and a flange portion 31b formed on one end of the shaft main body 31a. The flange portion 31b is positioned on the baseplate 21 side of the hard disk drive device 10 (see FIG. 2) and is attached to the baseplate 21. One end of the second inner ring 52 of the second bearing is in contact with the flange portion 31b of the shaft.

The pivot assembly bearing 30 of the present embodiment uses the rolling bearings filled with the above grease composition according to an embodiment of the present invention as the first and second bearings 40, 50.

Rolling bearings in general only rotate in one direction. However, since the pivot assembly bearing device 30 needs to move the magnetic head 25 of the hard disk drive 20 on the magnetic disk 23, it performs high-speed swing motion with repeated movement in one and another directions at a minute angle. In addition, the pivot assembly bearing device 30 needs to move the magnetic head 25 to precise position with high response speed.

The grease composition according to the present embodiment can reduce age hardening, achieve an appropriate oil separation amount, and exhibit an excellent fluidity (grease shape retainability). Therefore, it is possible to prevent local rise of torque, torque irregularity due to insufficient supply of lubricant, and contamination due to oil leakage. In addition, a stable torque at initial stage of use and also after long-term use, i.e. initial and long-term torque stabilities can be achieved.

As a result, the hard disk drive 20 according to the present embodiment can stably drive the rolling bearings (the first and second bearings 40, 50) for a long time with low torque and small torque fluctuation. This will reduce disk reading errors in hard disk drive devices and extend the life of pivot assembly bearing devices and hard disk drive devices.

### EXAMPLE

Hereinafter, the present invention will be explained in details based on some examples according to an embodiment of the present invention. Again, the present invention is not limited to any of these examples.

Details for each component (including abbreviated information) used in the preparation of grease compositions in Examples and Comparative Examples are as follows.

### (a) Base Oil

Alkylnaphthalene: Alkylnaphthalene having the kinematic viscosity of 36 cSt at 40° C.

Mineral oil+PAO: Mixed oil of mineral oil and polyalphaolefin oil

Ester oil: Trioctyl trimellitate

PAO+ester oil: Mixed oil of polyalphaolefin oil and ester oil

### (b) Thickening Agent

Alicyclic aliphatics: Alicyclic aliphatic diurea compound

Aliphatic Aromatics: Aliphatic aromatic diurea compound

Aliphatics: Aliphatic diurea compound

[Preparation of Grease Composition]

The grease compositions of Examples 1 to 7 and Comparative Examples 1 to 11 in Table 1 were prepared by reacting isocyanate with amine in a base oil so as to make the thickening agents in the proportion with respect to the total mass of a grease composition as indicated in Table 1. Evaluation was then made for age hardening rate, oil separation amount, fluidity (storage elastic modulus and torque) and life characteristics (that is, average torque and peak-to-peak torque) of the obtained grease compositions through the following procedures. Table 1 shows the results obtained.

(1) Age Hardening Rate (Unit: %) Measurement and Evaluation Criteria

40 g of each prepared grease composition was placed flat in a glass petri dish, and the glass petri dish was left under an environment of 100° C. Unworked penetration of the grease composition before being left under the environment of 100° C. and unworked penetration of the grease composition after being left under the environment of 100° C. for 1000 hours were measured. Then, age hardening rate (%) was calculated according to the following formula and evaluated based on the following criteria:

Age hardening rate (%)=[(X−Y)/X]×100 (Formula 1)

X: Unworked penetration of the grease composition before being left for 1000 hours under the environment of 100° C.
Y: Unworked penetration of the grease composition after being left for 1000 hours under the environment of 100° C.

### <Evaluation Criteria>

A: Age hardening rate is less than 20%
B: Age hardening rate is 20% or more but 40% or less
N: Age hardening rate exceeds 40%
The letters A, B and N above indicate the evaluation level and mean respectively “Preferable,” “Acceptable” and “Improper.” The letters will be used with same meanings for all evaluated items.

(2) Oil Separation Amount (Unit: Mm²/Mg) Measurement and Evaluation Criteria

9 mg of each prepared grease composition in a form of 3 mm diameter column was left on the surface of a medicine paper at the side aimed to place medicine, and has been left for 24 hours under the environment of 80° C. After the passage of 24 hours, the area of oil bleeding portions generated on the medicine paper was measured. The area of the oil bleeding portion per mass of the grease composition was calculated as Oil separation amount (mm²/mg). The Oil separation amount was then evaluated based on the following criteria.

In this test, the medicine paper used was “Pure white imitation Japanese vellum (medium)” made by HAKUAISHA CO., LTD. (size: 105 mm×105 mm, thickness: 42 μm, weight per area: 30 g/m², material: simili paper). As explained, the grease composition was set on the side (glossy surface) aimed to place medicine.

### <Evaluation Criteria>

N: Oil separation amount is less than 200 mm²/mg
B: Oil separation amount is 200 mm²/mg or more and less than 230 mm²/mg
A: Oil separation amount is 230 mm²/mg or more and 280 mm²/mg or less
B: Oil separation amount is more than 280 mm²/mg and 300 mm²/mg or less
N: Oil separation amount exceeds 300 mm²/mg

(3) Storage Elastic Modulus (Unit: Pa)

Storage elastic modulus is the value that denotes the shape stability of grease and is also effective parameters to understand the shape retainability of grease immediately after grease is enclosed in bearing devices or when the bearing devices are swung.

For example, in pivot assembly bearing devices, since grease is placed only on the crown type retainer, if the shape of grease collapses, the grease spreads and adheres to the balls and the races, thereby causing torque rise or torque irregularity in rolling bearings. Therefore, in order to obtain initial and long-term torque stabilities, the shape retainability of grease is one of the important elements.

From the viewpoint of the shape retainability of grease, storage elastic modulus is preferably 150 Pa or more. However, if the storage elastic modulus is too high, resistance will rise when balls climb over grease. Thus, in consideration of the torque rises, storage elastic modulus is preferably within values that do not exceed 720 Pa.

Storage Elastic Modulus (Unit: Pa) Measurement and Evaluation Criteria

The storage elastic modulus G′ for each grease composition was measured with a rotational viscometer manufactured by Anton Paar Co., Ltd. The measurement was carried out by the following condition: the measurement mode is strain dispersion method (strain is converted from 100% to 0.01%); the jig is a parallel plate of 25 mm diameter (PP 25); the plate gap is 1 mm; and the temperature is 25° C. The value immediately after starting measurement was considered as the storage elastic modulus G′(Pa), and storage elastic modulus was evaluated based on the following criteria.

### <Evaluation Criteria>

N: Storage elastic modulus is less than 150 Pa
B: Storage elastic modulus is 150 Pa or more and less than 200 Pa
A: Storage elastic modulus is 200 Pa or more and 600 Pa or less
B: Storage elastic modulus is more than 600 Pa and 720 Pa or less
N: Storage elastic modulus exceeds 720 Pa

(4) Torque (Unit: mN·m)

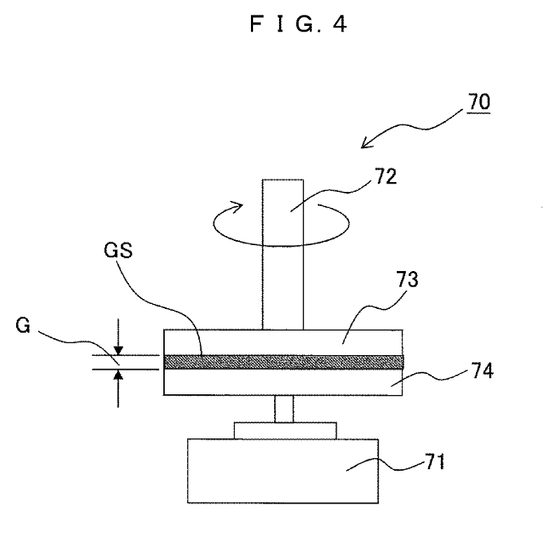

By using the rotational rheometer of FIG. 4, torque was measured based on each grease composition of Examples and Comparative Examples.

A rotational rheometer device 70 includes mainly a torque meter 71, an upper rotating plate 73 rotating around a rotating shaft 72 and a lower fixing plate 74. A gap G between the upper rotating plate 73 and the lower fixing plate 74 was set to 0.5 mm, and the grease composition GS of each of Examples and Comparative examples was sandwiched between the plates and was left under the environment of 25° C. Then, measurement was made to starting torque (that is, the maximum value at the start of rotation) when the upper rotating plate 73 was rotated at the shear speed of 100 s⁻¹. A plate having the diameter of 25 mm was used for each of the upper rotating plate 73 and the lower fixing plate 74.

Each Example and Comparative Example was evaluated according to the following criteria based on torque values measured.

### <Evaluation Criteria>

N: Torque exceeds 0.6 mN·m
B: Torque is more than 0.5 mN·m and 0.6 mN·m or less
A: Torque is 0.1 mN·m or more and 0.5 mN·m or less
B: Torque is 7×10⁻⁶ mN·m or more and less than 0.1 mN·m
N: Torque is less than 7×10⁻⁶ mN·m

(5) Life Characteristics

A test for life characteristics was conducted according to the following procedure in order to identify life characteristics of each grease composition in Examples and Comparative examples.

As the test for life characteristics, a pivot assemble bearing provided with ball bearings including grease composition was set in a oscillation tester, and the pivot assemble bearing was oscillated 200 million seeks with the oscillation amplitude of 20 degrees, the oscillation frequency of 55 Hz, and at the test temperature of 80° C.

Next, average torque and peak-to-peak torque at a room temperature were measured after the test was completed. The life of each grease composition was then measured referring to the following evaluation criteria. Here, in addition to the measurement of the average torque value and the peak-to-peak torque value after the test, seek marks on the race surface, seizing of the grease composition, discoloration of the grease composition, and sludge generation conditions were also confirmed.

Note that the “average torque” means average torque values when a pivot assembly bearing device is rotated 360° in each pivot assembly bearing device. The torque value was measured 4000 times while the pivot assembly bearing device was rotated 360°, and the average torque of one pivot assembly bearing device was obtained by calculating the average of 4000 measurements. Average torque of each Example and Comparative example is the average value of average torque in each of five samples.

Also, in each pivot assembly bearing device, “peak-to-peak torque” means the value of difference (maximum amplitude value) between the maximum peak value and the minimum peak value at 4000 torque values measured when the pivot assembly bearing device is rotated 360°. Peak-to-peak torque of each Example and Comparative example is the average value of average peak-to-peak torque in each of five samples.

### <Evaluation Criteria: Average Torque>

A: 0.6 gf·cm or less
B: more than 0.6 gf·cm and 0.8 gf·cm or less
N: exceeding 0.8 gf·cm

### <Evaluation Criteria: Peak-to-Peak Torque>

A: 0.9 gf·cm or less
B: more than 0.9 gf·cm and 1.0 gf·cm or less
N: exceeding 1.0 gf·cm

TABLE 1

| | | | | | Evaluation | | | | | |
|---|---|---|---|---|---|---|---|---|---|---|
| | | Grease composition | | | Age | Oil | Fluidity | | Life characteristics | |
| | | | Thickening | Mixed | hardening | separation | Storage elastic | | Peak-to-peak | Average |
| | | Base oil | agent | amount* | rate | amount | modulus | torque | torque | Torque |
| Comparative | 1 | Mineral oil + PAO | Alicyclic aliphatics | 10% | N | A | A | A | B | B |
| Example | 2 | Ester oil | Aliphatics | 12% | B | A | N | N | N | N |
| | 3 | PAO + Ester oil | Aliphatic aromas | 12% | B | B | N | N | N | B |
| | 4 | Ester oil | Aliphatic aromas | 12% | B | N | A | A | N | N |
| | 5 | Ester oil | Alicyclic aliphatics | 17% | B | N | A | N | N | B |
| | 6 | Ester oil | Alicyclic aliphatics | 13% | B | N | A | N | N | N |
| | 7 | Ester oil | Alicyclic aliphatics | 12% | B | N | A | N | N | B |
| | 8 | Alkylnaphthalene | Alicyclic aliphatics | 11% | B | N | B | A | N | B |
| | 9 | Alkylnaphthalene | Alicyclic aliphatics | 3% | B | N | N | B | N | N |
| | 10 | Alkylnaphthalene | Lithium soap | 13% | A | B | B | N | N | N |
| | 11 | Alkylnaphthalene | Clay | 8% | A | A | N | A | N | N |
| Example | 1 | Alkylnaphthalene | Alicyclic aliphatics | 10% | A | A | A | A | A | A |
| | 2 | Alkylnaphthalene | Alicyclic aliphatics | 9% | A | A | A | A | A | A |
| | 3 | Alkylnaphthalene | Alicyclic aliphatics | 8% | A | A | A | A | A | A |
| | 4 | Alkylnaphthalene | Alicyclic aliphatics | 7% | A | A | A | A | A | A |
| | 5 | Alkylnaphthalene | Alicyclic aliphatics | 6% | A | A | A | A | A | A |
| | 6 | Alkylnaphthalene | Alicyclic aliphatics | 5% | A | A | B | A | B | A |
| | 7 | Alkylnaphthalene | Alicyclic aliphatics | 4% | B | B | B | A | B | B |

*Mixed amount: Percentage (% by mass) of thickening agent relative to the total mass of grease composition

As shown in Table 1, regarding each grease composition in Examples 1 to 7 in which alkylnaphthalene as base oil and an alicyclic aliphatic diurea compound as thickening agent were mixed at 4 mass % to 10 mass % with respect to the total amount of the grease composition, the following results were obtained: torque were all preferable (A); and age hardening rate, oil separation amount and storage elastic modulus were preferable (A) or mostly preferable (B).

In particular, each grease composition of Examples 1 to 5 in which thickening agent was mixed at 6 mass % to 10 mass % was all preferable for age hardening rate, oil separation amount, storage elastic modulus and torque (A).

On the other hand, in the grease composition of Comparative Example 1 using the mixed base oil of a mineral oil and polyalphaolefin instead of alkylnaphthalene as base oil, age hardening rate became as high as over 40% (N), resulting in that problems such as bumps will be expected to occur due to the age hardening of the grease composition.

In the grease composition of Comparative Example 2 in which an ester oil was used as base oil and an aliphatic diurea compound was used as thickening agent, each evaluation result of storage elastic modulus and torque was improper (N).

Further, even in the grease composition of Comparative Example 3 in which polyalphaolefin and an ester oil were used as mixed base oil while an aliphatic aromatic diurea compound was used as thickening agent, the evaluation results of both storage elastic modulus and torque were all improper (N).

Still further, in the grease composition of Comparative Example 4 using an ester oil as base oil and an aliphatic aromatic diurea compound as thickening agent, although some improvement could have been seen in fluidity compared to Comparative example 2 where the aliphatic diurea compound was used as thickening agent, the evaluation result of oil separation amount was still improper (N).

Yet still further, in each grease composition of Comparative Examples 5 to 7 in which an ester oil was used as Base oil and an alicyclic aliphatic diurea compound used in the present invention was used as thickening agent, each evaluation of oil separation amount was poor, and even if the mixed amount of thickening agent was changed to 17 mass % to 12 mass %, each result of oil separation amount was improper (N).

In addition, all of these grease compositions of Comparative Examples 2 to 7 had age hardening rate of 20% or more but 40% or less (B), resulting in that even though an occurrence rate decreases, there still remains some possibilities of bump occurrence.

Moreover, in Comparative Example 8 and Comparative Example 9 in which alkylnaphthalene was used as Base oil and an alicyclic aliphatic diurea compound was used as thickening agent, when the mixing amount of thickening agent was made more than the specified amount of the present invention (11 mass %), oil separation amount became too low (see Comparative Example 8). On the other hand, if the mixing amount of thickening agent was made too small relative to the specified amount of the present invention (3 mass %), not only oil separation amount became too large, but also the evaluation result of storage elastic modulus became improper (N) (see Comparative Example 9).

In Comparative Example 10 and Comparative Example 11, alkylnaphthalene applied in the present invention was used as base oil. Then, in Comparative Example 10 that used well known lithium soap as thickening agent, the evaluation of torque was improper (N). On the other hand, in Comparative Example 11 using clay, which is known to be excellent in heat resistance, storage elastic modulus was improper (N).

Further, regarding life characteristics, each result of average torque and peak-to-peak torque was all preferable (A) in Examples 1 to 5. In Example 6, the result of average torque was preferable (A) while the result of peak-to-peak torque was acceptable (B). On the other hand, each result of average torque and peak-to-peak torque in Example 7 was acceptable (B).

In contrast, in Comparative examples in which base oil types, thickening agent types and a mixing amount of thickening agent are different from the one defined by the present invention, peak-to-peak torque became all improper (N) except Comparative example 1. Further, about half of average torque was resulted in being improper (N).

Based on the results, it has been confirmed that the grease compositions of Examples have longer life compared with the life of Comparative examples.

Based on the above test results, it was confirmed that using alkylnaphthalene as base oil and mixing alicyclic aliphatic diurea compound as thickening agent in an amount of 4 mass % to 10 mass %, preferably 6 mass % to 10 mass % reduces age hardening of grease and thus grease with longer life, proper oil separation amount and excellent grease shape retainability can be obtained. In addition, it was confirmed that, when the base oil types, thickening agent types or the mixing amount of thickening agent is not as the above, the three effects, namely reduction of grease age hardening, proper oil separation amount and excellent shape retainability cannot be achieved simultaneously.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A grease composition comprising:
(a) alkylnaphthalene as a base oil; and
(b) a urea compound as a thickening agent, wherein
the thickening agent (b) is an alicyclic aliphatic diurea compound and is contained at a ratio of 4 mass % to 10 mass % based on the total mass of the grease composition.

2. The grease composition according to claim 1 wherein the thickening agent (b) is contained at a ratio of 6 mass % to 10 mass % based on the total mass of the grease composition.

3. The grease composition according to claim 1, wherein
an age hardening rate calculated according to the following formula does not exceed 20% when the grease composition is left for 1000 hours under an environment of 100° C.
Age hardening rate (%)=[(X−Y)/X]×100
where X is an unworked penetration of the grease composition before being left for 1000 hours under the environment of 100° C., and Y is an unworked penetration of the grease composition after being left for 1000 hours under the environment of 100° C.

4. The grease composition according to claim 1, wherein
an oil separation amount is between 200 mm²/mg and 300 mm²/mg, the oil separation amount being an area of an oil bleeding portion appearing on a medicine paper per mass of the grease composition, wherein
the area of the oil bleeding portion emerging on the medicine paper is measured after the grease composition being left for 24 hours under an environment of 80° C., wherein the grease composition of 9 mg forming a column of 3 mm diameter is placed on the medicine paper,

5. A rolling bearing, wherein the rolling bearing comprises the grease composition according to claim 1.

6. A pivot assembly bearing device that can swingably support a swing arm of a hard disk drive device, wherein the pivot assembly bearing device comprises at least one rolling bearing according to claim 5.

7. A hard disk drive device, wherein the hard disk drive device comprises the pivot assembly bearing device according to claim 6.
